(19) United States
(12) Patent Application Publication
(10) Pub. No.: US 2017/0269274 A1
(43) Pub. Date: Sep. 21, 2017

(54) METHOD FOR MANUFACTURING QUANTUM DOT POLARIZATION PLATE

(71) Applicant: Shenzhen China Star Optoelectronics Technology Co., Ltd., Shenzhen City (CN)

(72) Inventors: Xiaoping Cheng, Shenzhen City (CN); Yungjui Lee, Shenzhen City (CN)

(21) Appl. No.: 14/908,552

(22) PCT Filed: Dec. 21, 2015
(86) PCT No.: PCT/CN2015/098140

§ 371 Date: Jan. 29, 2016

(30) Foreign Application Priority Data
Oct. 12, 2015 (CN) 201510658524.4

(51) Int. Cl. G02B 5/30; G02F 1/1335; G02B 1/14

(52) U.S. Cl. CPC G02B 5/3041; G02B 1/14; G02F 1/133528; Y10S 977/774; Y10S 977/824; Y10S 977/815; Y10S 977/814; Y10S 977/891; Y10S 977/892; Y10S 977/952; B82Y 20/00

(57) ABSTRACT

The present invention provides a method for manufacturing a quantum dot polarization plate. The method for manufacturing a quantum dot polarization plate according to the present invention forms a quantum dot layer and a polarization layer separately on different bases to respectively make a quantum dot film and a polarization film and then bonds the quantum dot film and the polarization film together to form a quantum dot polarization plate. The quantum dot polarization plate is not made through successive formations of films on the same base so that the quantum dot layer of the quantum dot polarization plate can be manufactured through a high-temperature process or a low-temperature process, thereby expanding the range of material section and manufacture for quantum dots. The quantum dot polarization plate manufactured with such process helps increase color gamut coverage of the display panel, but does not cause elimination of light polarization.

### BACKGROUND OF THE INVENTION

1. Field of the Invention

The present invention relates to the field of display technology, and in particular to a method for manufacturing a quantum dot polarization plate.

2. The Related Arts

To meet the needs of people for wide color gamut and high color saturation of display devices, an effective option for the major display manufacturers is to add photo-luminescent quantum dots devices in the backlight structure.

Quantum dot is a nanometer scale material, having a relatively narrow size (<10 nanometers) and exhibiting significant quantum confinement effect, and when exciting energy exceeds the energy gap thereof, electrons may migrate from valence band to conduction band, and is converted into the form of photo energy so as to display different colors. It is possible to make adjustment for different colors by controlling the size of the quantum dot itself. Using a backlight LED (Light-Emitting Diode) light emitting blue light to excite quantum dot, color gamut of a display may be effectively expanded.

However, light, after passing through a quantum dot, is emitted randomly in direction. On the other hand, the operation principle of a liquid crystal display (LCD) device is based on rotation of polarization and birefringence of liquid crystal so that through application of an electrical voltage to control the rotation of liquid crystal, linear polarized light passing through an upper polarizer would be rotated to transmit through a lower polarizer (that has a polarization direction perpendicular to that of the upper polarizer), whereby the upper and lower polarizers and a liquid crystal cell collectively function as an optic switch. It is quite apparent that such an optic switch is generally ineffective to light emitting from a quantum dot. When spread light that passes through a quantum dot travels through liquid crystal, it no longer possible to have the light passing through a pixel well controlled and LCD would suffer leakage of light.

As shown in FIG. 1, a regular polarization plate is made up of multiple layers of films combined together, generally including the following layers, which are, in sequence from top to bottom, a surface protection film 110, a first protection layer 120, a polarization layer 130, a second protection layer 140, an adhesive layer 150, and a peeling protection film 160. To attach the polarization plate, as shown in FIG. 2, the peeling protection film 160 is peeled off to expose the adhesive layer 150 and after the polarization plate is attached, the surface protection film 110 is often removed. In the structure of the polarization plate, the core portion is the polarization layer 130, which is generally a polyvinyl alcohol (PVA) layer containing therein iodine molecules that has an effect of light polarization. The first protection layer 120 and the second protection layer 140 are both transparent triacetyl cellulose (TAC) layers primarily for maintaining the polarizers of the polarization layer 130 in a stretched condition, preventing the polarizers from losing moisture, and protecting them from external influence.

To prevent the situation of light polarization being eliminated when quantum dots are introduced into a liquid crystal cell, a technical solution of a quantum dot polarization plate has been proposed to set the quantum dots in a polarization plate. However, it is known that the light polarizing materials that are currently known are generally of poor stability of heat resistance. Thus, if quantum dots are to be made on the basis of the light polarizing materials, then the manufacturing process of quantum dots must be a low-temperature process. This imposes constraints to the range of material selection and manufacture for quantum dots.

Thus, it is desired to have a method for manufacturing a quantum dot polarization plate that overcomes the above problems.

### SUMMARY OF THE INVENTION

An object of the present invention is to provide a method for manufacturing a quantum dot polarization plate, in which comprises a quantum dot layer and a polarization layer are respectively formed on different bases so that the quantum dot may be made by means of both high-temperature and low-temperature processes thereby expanding the range of material selection and manufacture for the quantum dots.

To achieve the above object, the present invention provides a method for manufacturing a quantum dot polarization plate, which comprises the following steps:

(1) providing a first base and forming a quantum dot layer, a first protection layer, and a first adhesive layer on the first base to obtain a quantum dot film;

(2) providing a second base and forming a polarization layer, a second protection layer, a second adhesive layer, and a peeling protection film on the second base to obtain a polarization film; and

(3) bonding the quantum dot film and the polarization film together by means of the first adhesive layer to obtain a quantum dot polarization plate.

In step (1), the quantum dot layer comprises therein quantum dots that comprises one of semiconductor materials formed of II-VI group elements, semiconductor materials formed of III-V group elements, and carbon quantum dot, or multiple ones thereof; and the quantum dots are nanometer particles having a stable diameter in the range of 0-20 nm.

The polarization film formed in step (2) is an iodine-series polarization film or a dye-series polarization film.

In step (1), a quantum dot film is formed on the first base by means of a vapor deposition process to form the quantum dot layer.

The vapor deposition process comprises molecular beam epitaxy or organic metal chemical vapor deposition.

In step (1), the quantum dot layer is formed on the first base by the following process: providing a quantum dot material and a dissolving medium, dissolving and dispersing the quantum dot material in the dissolving medium and uniformly mixing to make a quantum dot paste, and applying the quantum dot paste to the first base to form a film, which after being dried and cured, forms the quantum dot layer.

The quantum dot material is made by subjecting quantum dots to surface modification through surface grafting or surface coating and the quantum dot material is oil soluble or water soluble; and the quantum dots have a shape of sphere, bar, or fibrous forms.

In step (1), the quantum dot paste is applied through spray coating, spin coating, printing, or slot-die coating to form the film on the first base.

The quantum dot polarization plate formed in step (3) is applicable as an upper polarizer or a lower polarizer of a liquid crystal display panel.

The quantum dot film formed in step (1) comprises, in sequence from top to bottom, the first base, the first protection layer, the quantum dot layer, and the first adhesive layer; and the polarization film formed in step (2) comprises, in sequence from top to bottom, the polarization layer, the second protection layer, the second base, the second adhesive layer, and the peeling protection film; in step (3), the quantum dot polarization plate is formed by bonding the first adhesive layer to the polarization layer of the polarization film; and to use the quantum dot polarization plate, the peeling protection film is peeled off and the quantum dot polarization plate is attached to an external substrate by the second adhesive layer.

The present invention also provides a method for manufacturing a quantum dot polarization plate, which comprises the following steps:

(1) providing a first base and forming a quantum dot layer, a first protection layer, and a first adhesive layer on the first base to obtain a quantum dot film;

(2) providing a second base and forming a polarization layer, a second protection layer, a second adhesive layer, and a peeling protection film on the second base to obtain a polarization film; and

(3) bonding the quantum dot film and the polarization film together by means of the first adhesive layer to obtain a quantum dot polarization plate;

wherein in step (1), the quantum dot layer comprises therein quantum dots that comprises one of semiconductor materials formed of II-VI group elements, semiconductor materials formed of III-V group elements, and carbon quantum dot, or multiple ones thereof; and the quantum dots are nanometer particles having a stable diameter in the range of 0-20 nm;

wherein the polarization film formed in step (2) is an iodine-series polarization film or a dye-series polarization film;

wherein the quantum dot polarization plate formed in step (3) is applicable as an upper polarizer or a lower polarizer of a liquid crystal display panel; and

wherein the quantum dot film formed in step (1) comprises, in sequence from top to bottom, the first base, the first protection layer, the quantum dot layer, and the first adhesive layer; and the polarization film formed in step (2) comprises, in sequence from top to bottom, the polarization layer, the second protection layer, the second base, the second adhesive layer, and the peeling protection film; in step (3), the quantum dot polarization plate is formed by bonding the first adhesive layer to the polarization layer of the polarization film; and to use the quantum dot polarization plate, the peeling protection film is peeled off and the quantum dot polarization plate is attached to an external substrate by the second adhesive layer.

The efficacy of the present invention is that the present invention provides a method for manufacturing a quantum dot polarization plate. The method for manufacturing a quantum dot polarization plate according to the present invention forms a quantum dot layer and a polarization layer separately on different bases to respectively make a quantum dot film and a polarization film and then bonds the quantum dot film and the polarization film together to form a quantum dot polarization plate. The quantum dot polarization plate is not made through successive formations of films on the same base so that the quantum dot layer of the quantum dot polarization plate can be manufactured through a high-temperature process or a low-temperature process, thereby expanding the range of material section and manufacture for quantum dots. The quantum dot polarization plate manufactured with such process helps increase color gamut coverage of the display panel, but does not cause elimination of light polarization.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a cross-sectional view showing the structure of a conventional polarization plate;

FIG. 2 is a flow chart illustrating a method for manufacturing a quantum dot polarization plate according to the present invention; and

FIG. 3 is a schematic view showing step 3 of the method for manufacturing a quantum dot polarization plate according to the present invention.

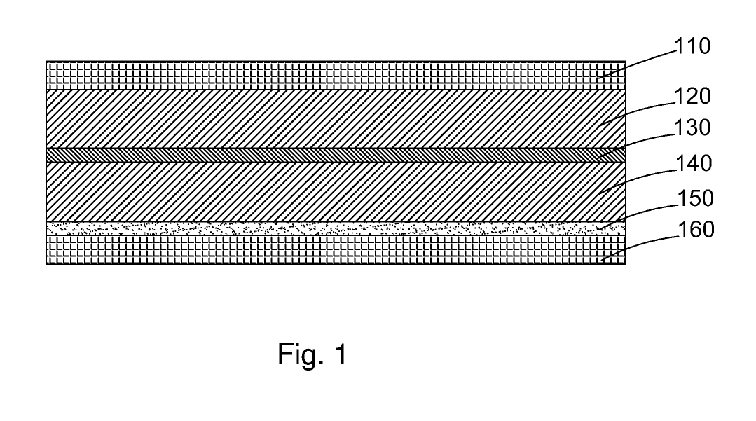

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

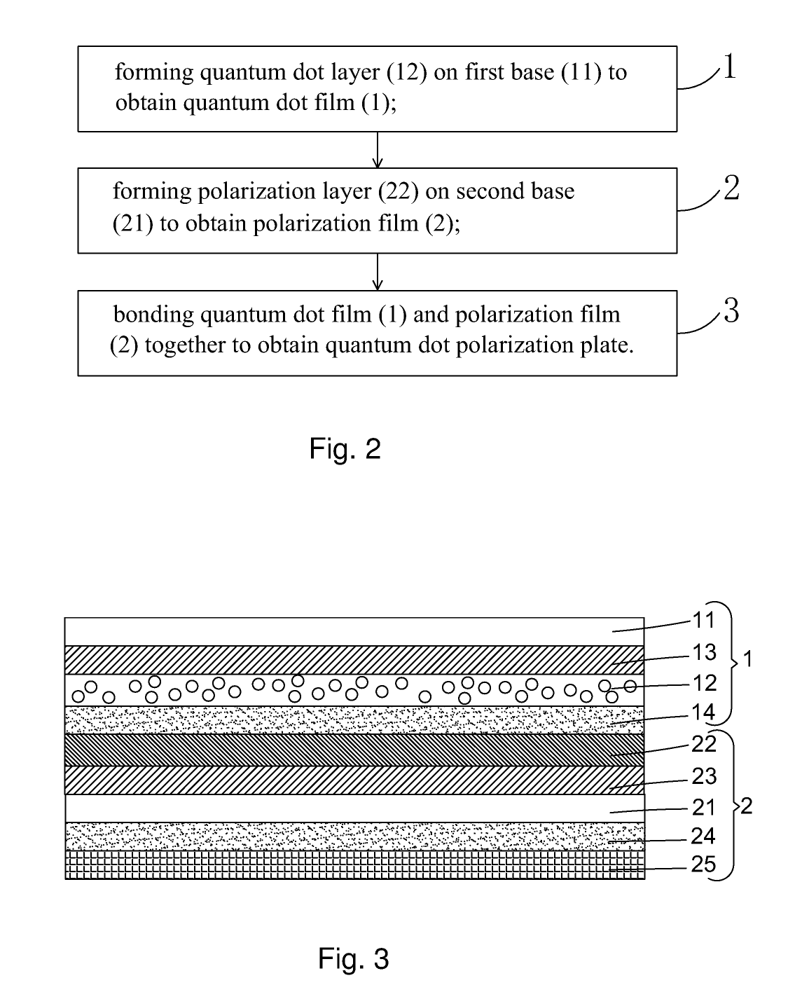

Referring to FIGS. 2-3, the present invention provides a method for manufacturing a quantum dot polarization plate, which comprises the following steps:

Step 1: providing a first base 11 and forming a quantum dot layer 12, a first protection layer 13, and a first adhesive layer 14 on the first base 11 to obtain a quantum dot film 1;

Step 2: providing a second base 21 and forming a polarization layer 22, a second protection layer 23, a second adhesive layer 24, and a peeling protection film 25 on the second base 21 to obtain a polarization film 2; and

Step 3: bonding the quantum dot film 1 and the polarization film 2 together by means of the first adhesive layer 14 to obtain a quantum dot polarization plate.

The formation of the layers/films in Step 1 and Step 2 can be conduction in any sequence.

Specifically, in Step 1, the quantum dot layer 12 comprises therein quantum dots that comprises one of semiconductor materials formed of II-VI group elements (such as: cadmium sulfide (CdS), cadmium selenide (CdSe), mercury telluride (HgTe), zinc sulfide (ZnS), zinc selenide (ZnSe), zinc telluride (ZnTe), and mercury sulfide (HgS)), semiconductor materials formed of III-V group elements (such as: indium phosphide (InP), indium arsenide (InAs), gallium phosphide (GaP), and gallium arsenide (GaAs)), and carbon quantum dot, or multiple ones thereof. The quantum dots are nanometer particles having a stable diameter in the range of 0-20 nm. Preferably, the quantum dot layer 12 comprises therein multiple types of quantum dot to provide a better effect of increasing color gamut rang and mixture.

Specifically, the polarization film 2 formed in Step 2 is an iodine-series polarization film or a dye-series polarization film.

Since the quantum dot layer 12 and the polarization layer 22 are respectively formed on different bases, the quantum dot layer 12 is allowed to be manufactured with a high-temperature process, such as vapor deposition, or a low-temperature process, such as solution-casting film formation process, including spray coating, spin coating, printing.

Specifically, in Step 1, a quantum dot film is formed on the first base 11 by means of vapor deposition, such as molecular beam epitaxy, organic metal chemical vapor deposition, or other vapor deposition processes to obtain the quantum dot layer 12.

Or alternatively, in Step 1, a specific process for forming the quantum dot layer 12 on the first base 11 is: providing a quantum dot material and a dissolving medium, dissolving and dispersing the quantum dot material in the dissolving medium and uniformly mixing to make a quantum dot paste, and applying the quantum dot paste to the first base 11 to form a film, which after being dried and cured, forms the quantum dot layer 12. Specifically, the quantum dot material is obtained by subjecting quantum dots to surface modification through surface grafting or surface coating and the quantum dot material is oil soluble or water soluble. The quantum dots may have a shape of sphere, bar, or fibrous forms. In Step 1, the quantum dot paste is applied through spray coating, spin coating, printing, or slot-die coating to form a film on the first base 11.

Specifically, as shown in FIG. 3, the quantum dot film 1 formed in Step 1 comprises, in sequence from top to bottom, the first base 11, the first protection layer 13, the quantum dot layer 12, and the first adhesive layer 14; and the polarization film 2 formed in Step 2 comprises, in sequence from top to bottom, the polarization layer 22, the second protection layer 23, the second base 21, the second adhesive layer 24, and the peeling protection film 25; in Step 3, the quantum dot polarization plate is formed by bonding the first adhesive layer 14 to the polarization layer 22 of the polarization film 2; to use the quantum dot polarization plate, the peeling protection film 25 is peeled off and the quantum dot polarization plate is attached to a substrate to be attached thereto by the second adhesive layer 24.

Specifically, the quantum dot polarization plate formed in Step 3 may serve as an upper polarizer or a lower polarizer of a liquid crystal display panel or is applicable to other applications for polarization of light.

The method for manufacturing a quantum dot polarization plate of the present invention is applicable to BOA (Black matrix On Array), COA (Color filter On Array), and GOA (Gate Driver on Array) liquid crystal panels. No constraint is imposed for the mode of driving a display panel and application may be made to display panels of various modes, including IPS (In-Plane Switching), TN (Twisted Nematic), VA ((Vertical Alignment), OLED (Organic Light-Emitting Diode), and QLED (Quantum Dot Light-Emitting Diode).

In summary, the present invention provides a method for manufacturing a quantum dot polarization plate, in which a quantum dot layer and a polarization layer are respectively formed on different bases to respectively make a quantum dot film and polarization film, and then, the quantum dot film and the polarization film are bonded together to form a quantum dot polarization plate. The quantum dot polarization plate is not made through successive formations of films on the same base so that the quantum dot layer of the quantum dot polarization plate can be manufactured through a high-temperature process or a low-temperature process, thereby expanding the range of material section and manufacture for quantum dots. The quantum dot polarization plate manufactured with such process helps increase color gamut coverage of the display panel, but does not cause elimination of light polarization.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A method for manufacturing a quantum dot polarization plate, comprising the following steps:
(1) providing a first base and forming a quantum dot layer, a first protection layer, and a first adhesive layer on the first base to obtain a quantum dot film;
(2) providing a second base and forming a polarization layer, a second protection layer, a second adhesive layer, and a peeling protection film on the second base to obtain a polarization film; and
(3) bonding the quantum dot film and the polarization film together by means of the first adhesive layer to obtain a quantum dot polarization plate.

2. The method for manufacturing a quantum dot polarization plate as claimed in claim 1, wherein in step (1), the quantum dot layer comprises therein quantum dots that comprises one of semiconductor materials formed of II-VI group elements, semiconductor materials formed of III-V group elements, and carbon quantum dot, or multiple ones thereof; and
the quantum dots are nanometer particles having a stable diameter in the range of 0-20 nm.

3. The method for manufacturing a quantum dot polarization plate as claimed in claim 1, wherein the polarization film formed in step (2) is an iodine-series polarization film or a dye-series polarization film.

4. The method for manufacturing a quantum dot polarization plate as claimed in claim 1, wherein in step (1), a quantum dot film is formed on the first base by means of a vapor deposition process to form the quantum dot layer.

5. The method for manufacturing a quantum dot polarization plate as

4. in claim 4, wherein the vapor deposition process comprises molecular beam epitaxy or organic metal chemical vapor deposition.

6. The method for manufacturing a quantum dot polarization plate as claimed in claim 1, wherein in step (1), the quantum dot layer is formed on the first base by the following process: providing a quantum dot material and a dissolving medium, dissolving and dispersing the quantum dot material in the dissolving medium and uniformly mixing to make a quantum dot paste, and applying the quantum dot paste to the first base to form a film, which after being dried and cured, forms the quantum dot layer.

7. The method for manufacturing a quantum dot polarization plate as claimed in claim 6, wherein the quantum dot material is made by subjecting quantum dots to surface modification through surface grafting or surface coating and the quantum dot material is oil soluble or water soluble; and the quantum dots have a shape of sphere, bar, or fibrous forms.

8. The method for manufacturing a quantum dot polarization plate as claimed in claim 6, wherein in step (1), the quantum dot paste is applied through spray coating, spin coating, printing, or slot-die coating to form the film on the first base.

9. The method for manufacturing a quantum dot polarization plate as claimed in claim 1, wherein the quantum dot polarization plate formed in step (3) is applicable as an upper polarizer or a lower polarizer of a liquid crystal display panel.

10. The method for manufacturing a quantum dot polarization plate as claimed in claim 1, wherein the quantum dot film formed in step (1) comprises, in sequence from top to bottom, the first base, the first protection layer, the quantum dot layer, and the first adhesive layer; and the polarization film formed in step (2) comprises, in sequence from top to bottom, the polarization layer, the second protection layer, the second base, the second adhesive layer, and the peeling protection film; in step (3), the quantum dot polarization plate is formed by bonding the first adhesive layer to the polarization layer of the polarization film; and to use the quantum dot polarization plate, the peeling protection film is peeled off and the quantum dot polarization plate is attached to an external substrate by the second adhesive layer.

11. A method for manufacturing a quantum dot polarization plate, comprising the following steps:
(1) providing a first base and forming a quantum dot layer, a first protection layer, and a first adhesive layer on the first base to obtain a quantum dot film;
(2) providing a second base and forming a polarization layer, a second protection layer, a second adhesive layer, and a peeling protection film on the second base to obtain a polarization film; and
(3) bonding the quantum dot film and the polarization film together by means of the first adhesive layer to obtain a quantum dot polarization plate;
wherein in step (1), the quantum dot layer comprises therein quantum dots that comprises one of semiconductor materials formed of II-VI group elements, semiconductor materials formed of III-V group elements, and carbon quantum dot, or multiple ones thereof; and the quantum dots are nanometer particles having a stable diameter in the range of 0-20 nm;
wherein the polarization film formed in step (2) is an iodine-series polarization film or a dye-series polarization film;
wherein the quantum dot polarization plate formed in step (3) is applicable as an upper polarizer or a lower polarizer of a liquid crystal display panel; and
wherein the quantum dot film formed in step (1) comprises, in sequence from top to bottom, the first base, the first protection layer, the quantum dot layer, and the first adhesive layer; and the polarization film formed in step (2) comprises, in sequence from top to bottom, the polarization layer, the second protection layer, the second base, the second adhesive layer, and the peeling protection film; in step (3), the quantum dot polarization plate is formed by bonding the first adhesive layer to the polarization layer of the polarization film; and to use the quantum dot polarization plate, the peeling protection film is peeled off and the quantum dot polarization plate is attached to an external substrate by the second adhesive layer.

12. The method for manufacturing a quantum dot polarization plate as claimed in claim 11, wherein in step (1), a quantum dot film is formed on the first base by means of a vapor deposition process to form the quantum dot layer.

13. The method for manufacturing a quantum dot polarization plate as claimed in claim 12, wherein the vapor deposition process comprises molecular beam epitaxy or organic metal chemical vapor deposition.

14. The method for manufacturing a quantum dot polarization plate as claimed in claim 11, wherein in step (1), the quantum dot layer is formed on the first base by the following process: providing a quantum dot material and a dissolving medium, dissolving and dispersing the quantum dot material in the dissolving medium and uniformly mixing to make a quantum dot paste, and applying the quantum dot paste to the first base to form a film, which after being dried and cured, forms the quantum dot layer.

15. The method for manufacturing a quantum dot polarization plate as claimed in claim 14, wherein the quantum dot material is made by subjecting quantum dots to surface modification through surface grafting or surface coating and the quantum dot material is oil soluble or water soluble; and the quantum dots have a shape of sphere, bar, or fibrous forms.

16. The method for manufacturing a quantum dot polarization plate as claimed in claim 14, wherein in step (1), the quantum dot paste is applied through spray coating, spin coating, printing, or slot-die coating to form the film on the first base.
